(19) United States
(12) Patent Application Publication
(10) Pub. No.: US 2012/0290243 A1
(43) Pub. Date: Nov. 15, 2012

(54) METHOD FOR AUTOMATED DETECTION OF INDIVIDUAL PARTS OF A COMPLEX DIFFERENTIAL STRUCTURE

(76) Inventors: Michael Grigoleit, Ammersbek (DE); Oliver Thomaschewski, Hamburg (DE); Rene Heiden, Lubeck (DE)

(21) Appl. No.: 13/466,238

(22) Filed: May 8, 2012

(30) Foreign Application Priority Data
May 9, 2011 (DE) 102011100919.5

(51) Int. Cl. G06F 19/00

(52) U.S. Cl. 702/84

(57) ABSTRACT

The invention relates to a method for the automated detection of individual parts of a complex differential structure. The method comprises the following steps:
a) acquiring the structure by conventional measurement methods,
b) creating a measurement point cloud of the acquired structure,
c) calculating one or more specification point clouds from a specification structure of the individual parts,
d) carrying out a fit of the specification point cloud into the measurement point cloud,
e) evaluating the fitting process in order to acquire the position deviation or missing or surplus individual parts.

The invention relates to a method for the automated detection of individual parts of a complex differential structure.

This method may, in particular, be used for quality control.

When preparing to internally fit out an airplane, a multiplicity of mounting components, for example holders for cables, pipes, internal cladding or the like need to be fixed on the primary structure of the fuselage. This may in particular involve clamps, metal brackets or the like.

When preparing to internally fit out a modern long-haul airplane, several tens of thousands of holders for cables, pipes or other components need to be fixed on the primary structure. After the mounting components have been applied, surface protection is generally applied onto the primary structure. If the lack or incorrect positioning of holders or other mounting components is not noticed until after this or in the course of the internal fitting out, this entails very considerable extra expense.

Besides visual inspection, quality assurance methods based on measurement data, for example laser scanning data, are known in particular. In this case, a specification/measurement comparison is carried out between CAD data and the acquired geometry. The result usually consists of color-coded deviation plots. This procedure is very suitable for monolithic components such as cast or milled parts. In the case of large differential structures, each part would have to be observed and evaluated individually. Furthermore, the result only provides limited information about the actual position since only a vector length of the deviation is usually known, but not the deviations in all three translation and rotation directions. To this extent, the conventional methods are only moderately suitable for the task.

It is therefore the object of the invention to provide a method of the type mentioned in the introduction, which with tolerable outlay makes it possible to check whether particular individual parts of a complex differential structure are actually installed and installed with dimensional compliance.

The invention achieves this object by the features of the patent claims. A method according to the invention comprises the following steps:
a) acquiring the structure by conventional measurement methods,
b) creating a measurement point cloud of the acquired structure,
c) calculating one or more specification point clouds from a specification structure of the individual parts,
d) carrying out a fit of the specification point cloud into the measurement point cloud,
e) evaluating the fitting process in order to acquire the position deviation or missing or surplus individual parts.

First, some of the terms used in the scope of the invention will be explained. A complex differential structure is a structure which is assembled from a multiplicity of individual parts. It is preferably an airplane fuselage, which typically comprises frames, stringers and an outer skin. Assembled means that these mounting parts are connected releasably (for example screwed) or non-releasably (for example riveted, adhesively bonded or welded) to the primary structure. Individual parts are parts which are a component of the overall structure; they may serve either as a component of the supporting structure or as mounting parts such as cable holders, clamps or the like, for example to prepare for internal fitting out.

The structure is first acquired three-dimensionally by suitable measurement methods. In particular, methods such as laser scanning, strip projection methods or photogrammetry are suitable. All these methods provide a point cloud as an image of the acquired structure.

From the 3D measurement data, a measurement point cloud of the scanned structure is created. This measurement point cloud indicates points of the structure, acquired by the measurement system used, in a three-dimensional coordinate system. The density of the point cloud may correspond to the available resolution of the 3D scanning system used. Alternatively, it is possible to select the point cloud density to be lower, for example in order to reduce the computing power required for the processing.

According to the invention, all or sections of the measurement point cloud are used in order to fit the point cloud or point clouds of the specification structures. The specification structure is the geometry of the individual parts as shown by the plans. From this specification structure, a specification point cloud is first of all calculated (optionally a plurality of specification point clouds), which is intended so to speak to represent a hypothetical scan result for the specification structure. The density and resolution of this specification point cloud therefore preferably correspond to those of the measurement point cloud. The calculation of the specification point cloud may, for example, be carried out from the CAD data of the specification structure.

In the next step, a fit of the specification point cloud into the measurement point cloud is carried out in order to identify the individual parts in the measurement point cloud. This fitting process may be carried out so as to minimize errors in the sense of the geometrical distance between the points of the specification point cloud and of the measurement point cloud, by displacing the specification measurement cloud into the measurement point cloud. To this end, the specification point cloud of the individual part should approximately be positioned in the correct place. One such method is, for example, the ICP algorithm which is known from the literature. The result of the fitting process is a 6D displacement vector from the theoretical specification position of the individual part to the acquired measurement position. In this way, the deviation of the measurement and specification positions can be fully described and evaluated. This procedure is carried out for each individual part.

Further errors may arise besides a positioning error, so that an individual part may have been planned but not installed, or may have been installed without having been planned to be there.

The second case, of a surplus individual part, may subsequently be recognized visually. After all the individual parts have been checked, the remaining points of the measurement point cloud, which do not belong to an identified component, may be displayed. They represent the surplus, unplanned rest of the structure.

In the first case, of a missing but planned component, a further challenge arises in practice. Large point clouds such as the measurement point cloud are liable to be such that small point clouds, such as the specification point cloud, can always be fitted in some way. In unfavorable constellations, for example flat individual parts in the vicinity of many flat structures, this may take place without a significant position error occurring. In order to pick up this effect, a further check may be carried out.

In this additional check, a comparison of the positioned specification point cloud with the measurement point cloud found in the laser scan, is carried out according to methods known in the prior art. Boundingbox: Jeffrey Goldsmith, John Salmon: Automatic Creation of Object Hierarchies for Ray Tracing In: Proceedings of IEEE Symposium on Computer Graphics and Applications, May 1987, p. 14-20, ISSN 0272-1716 describes the creation of a so-called boundingbox (discretization of the volume, as in a classical finite element method). For the comparison, the boundingboxes of the parts, found in the specification and measurement point clouds, are discretized and those elements which contain points are determined. If there are large intersection sets of the discrete volumes filled with points, the probability of a match of the point clouds is very high. If only a small intersection set is found, then it is probable that the above-described effect of incorrectly fitting a small specification point cloud into a large measurement point cloud has occurred.

The result of the overall examination is thus a vector from the specification position to the measurement position of each individual part examined, and a list of all uninstalled and surplus components from the check results described above.

When all relevant individual parts in the measurement point cloud have been checked, the quality assurance is completed. The structure (for example the airplane fuselage) can then be approved for further fitting out or further processing.

The invention allows simple and rapid checking of a complex differential structure for completeness and dimensional compliance. For example, the time required for scanning the interior of an airplane fuselage is generally at most a few hours. The further processing can be carried out almost fully automatedly and parallelizably with existing CAD data. The results may likewise be filtered automatedly for surplus deviations.

According to the current procedures when setting up airplane fuselages, conversely, the completeness and dimensional compliance of the individual parts have to be manually checked and evaluated. To this end, workers compare the mounting parts and their position with the CAD data, which may take several weeks.

The greatest dimension of a typical mounting component to be detected may according to the invention be between 1 and 50 cm, preferably between 2 and 30 cm. The term greatest dimension refers to the greatest extent in a spatial direction.

The three-dimensional acquisition of the structure is preferably carried out by means of optical scanning methods, particularly preferably by laser scanning. A laser scanning method as described in WO 2010/025910 A1 is particularly preferred. The disclosure of this document is also incorporated into the subject matter of the present application by reference. A laser profile scan is therefore particularly preferred, in which a laser scanner carrying out a scan in a plane is moved through the primary structure (the interior of the airplane fuselage), preferably along its longitudinal axis.

Even several scanning processes often do not acquire all the surfaces of the structure; rather, depending on the perspective, merely some of the surfaces since the remainder, for example relief cuts, remain shadowed and are not acquired. The effect of this is that an acquired front surface is positioned during the fitting process between the front and the rear surface, which was not acquired in the scan. This is correct in the sense of the least error between the specification and measurement point clouds, but leads to false positioning.

According to the invention, it is therefore preferred that, when calculating the specification point cloud for example from CAD data, this fact is taken into account and the specification point cloud likewise acquires only those points on the surface which can actually be acquired or illuminated in the intended scanning process. Since the parameters of the scanning process to be carried out are generally known before the specification point cloud is calculated, or this specification point cloud cannot be calculated until after having actually carried out a scanning process (therefore with known scanning parameters), such a computational restriction of the specification point cloud to actually illuminable surfaces is readily possible.

According to the invention, it is possible to decompose the measurement point cloud into a multiplicity of measurement point cloud regions before the comparison with the specification point cloud or the specification point clouds, each measurement point cloud region comprising the specification position of one or more mounting components. In this case, a fit of the specification point cloud into the complete measurement point cloud is not carried out, rather a fitting process less demanding in terms of the computation power, of only those regions in which individual parts are actually meant to be present according to the specification structure.

According to the invention, a list of the fitting results may be created, in which missing, surplus and/or matching individual parts are listed in comparison to the specification structure.

An exemplary embodiment of the invention will be explained below with the aid of the drawings, in which:

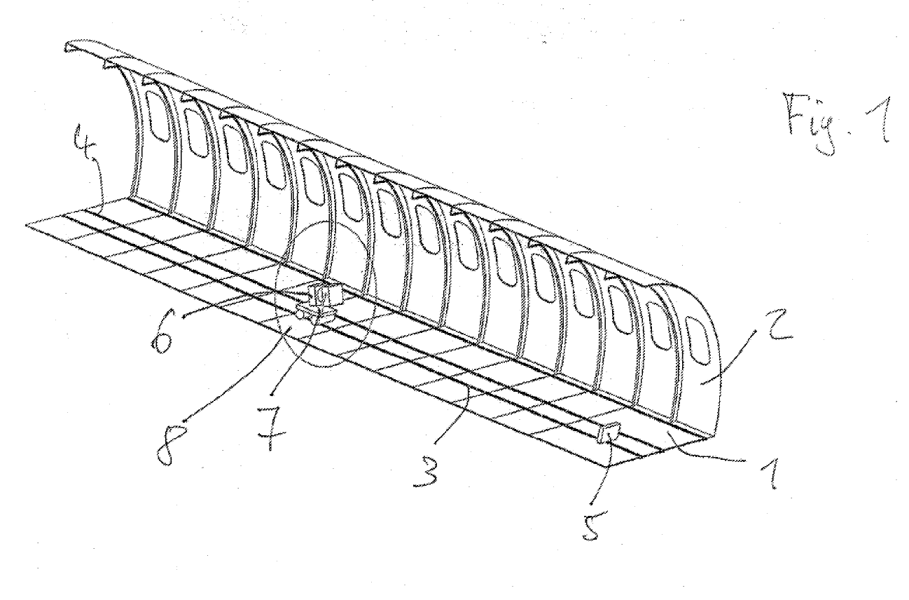

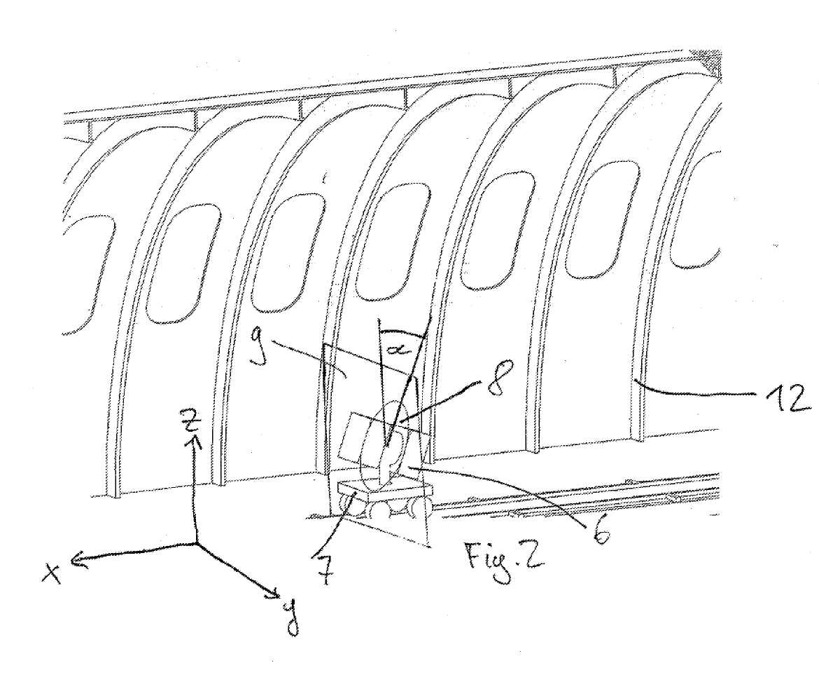

FIGS. 1 and 2 schematically show a section of an airplane fuselage with a laser scanner arranged therein;

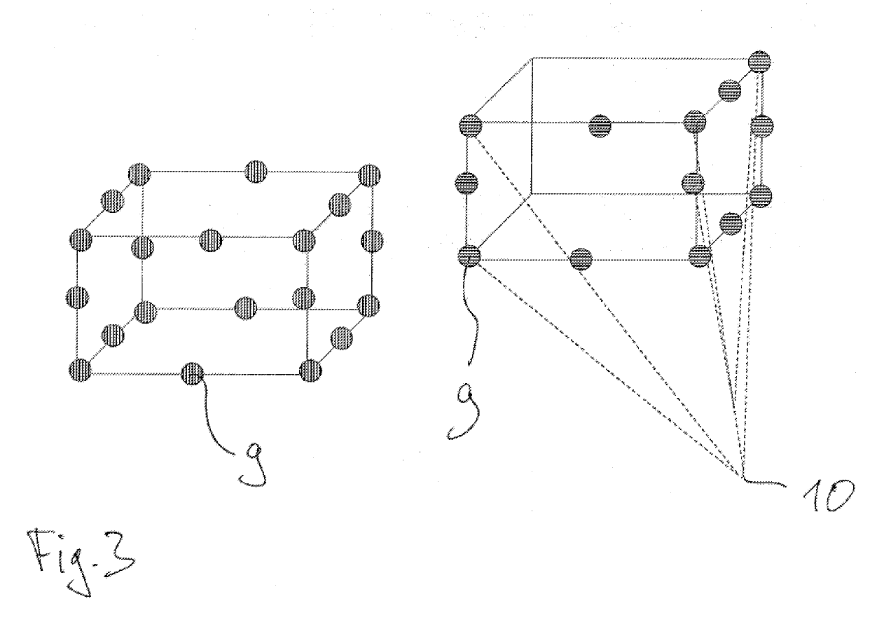

FIG. 3 schematically shows how the scanner perspective is taken into account for the point cloud comparison.

FIG. 1 shows in a section the interior of an airplane fuselage comprising the cabin floor 1 and the outer skin 2 of the fuselage with the frames 12. For the quality assurance, this fuselage segment needs to be measured with all individual parts.

On the cabin floor 1, two guide rails 3, 4 are arranged for carrying out the measurement, each of which extends essentially parallel to the longitudinal axis of the cabin. The two guide rails 3, 4 are arranged on different sides of the symmetry plane extending in the direction of the longitudinal axis, which extends through the airplane cabin in the xz plane.

At a known reference position in the airplane cabin, a reference, for example a reflector 5 of an optical positioning system, is arranged stationary. It is used as a reference for establishing the position of a laser scanner 6, which is arranged movably on a self-propelled carriage 7. The positioning system determines the distance travelled by measuring the separation of the carriage 7 from the stationary reference 5. The laser scanner 6 is formed in order to carry out so-called profile scans, in which the measurement beam for the measurement process is successively rotated about an axis perpendicular to the beam direction and a measurement is therefore carried out in a plane 8. It can be seen in particular from FIG. 2 that this scanning plane 8 is inclined by an angle a with respect to the plane 9 spanned by the y axis and the z axis of the coordinate system of the interior. Knowledge of the displacement position and the angle is subsequently used to calculate the optimum specification point cloud from the CAD parts.

In order to carry out a measurement, the carriage 7 is placed on one end of the guide rail 3. Scanning of the interior is then carried out in the scanning plane 8. In the course of the slow movement of the carriage 7 along the rail 3, this scanning plane 8 is moved through the entire interior to be measured, so that this is measured. The position of the carriage 7 during the measurement process is determined by means of the measurement system with the reference 5.

In a second step, the carriage 7 is placed on the guide rail 4 running parallel and the measurement process is repeated. During this second measurement process, the scanning plane 8 is tilted so that it now makes the angle −α with the yz plane 9. During this second scanning process, the interior is therefore measured with a different scanning plane.

The double measurement of the interior with different scanning planes allows complete or substantially complete illumination and therefore measurement of relatively complex relief cuts or comparable structures. Details of this procedure are described in the aforementioned WO 2010/025910 A1, to which reference is made here.

From the scan data, the measurement point cloud is calculated. The fitting of the specification point cloud into the measurement point cloud may for example be carried out by means of a procedure which is described in “Robotics and Autonomous Systems” 56 (2008) 915 to 926 (the section “Object Detection and Interpretation in 3D data” therein). The disclosure of this article is also incorporated by reference into the subject-matter of the present application.

FIG. 3 schematically shows how the scanner perspective is taken into account for calculating the specification point cloud, or comparison of the measurement and specification point clouds.

In FIG. 3, a cuboid is represented as an example of a three-dimensional body. The points indicated are a typical homogeneous point cloud, which describes such a cuboid with a particular resolution. Such a point cloud may be determined computationally from CAD data of the cuboid (specification point cloud).

The right-hand half of FIG. 3 shows those points of the measurement point cloud 9 which can be detected during an actual scanning process by means of a laser scanner placed at the assumed position 10. Only three of the six sides of the cuboid can be illuminated in this example; the measurement point cloud actually calculated from the measurement accordingly describes only three of the six sides of this cuboid.

So that mismatches do not occur during the fitting of the specification point cloud into the measurement point cloud, the specification point cloud is preferably calculated while taking the scanner perspective into account. This means that the calculated specification point cloud based on the CAD data does not describe all the surface structures, but only those surfaces which can actually be illuminated by the laser scanner during the intended scanning process. This “reduced” specification point cloud created while taking the scanner perspective into account can readily be fitted into the measurement point cloud measured. If significant deviations occur in this case, it is to be assumed that these are actually attributable to missing or defectively installed individual parts.

1. A method for the automated detection of individual parts of a complex differential structure, characterized by the following steps:
a) acquiring a structure by conventional measurement methods,
b) creating a measurement point cloud of the acquired structure,
c) calculating one or more specification point clouds from a specification structure of individual parts,
d) carrying out a fit of the specification point cloud into the measurement point cloud using a fitting process,
e) evaluating the fitting process in order to acquire the position deviation or missing or surplus individual parts.

2. The to method of claim 1, characterized in that the complex differential structure is the interior of an airplane fuselage.

3. The method of claim 1, characterized in that the individual parts are holders for cables, pipes or other components.

4. The method of claim 1, characterized in that the greatest dimension of an individual part is from 1 to 50 cm.

5. The method of claim 1, characterized in that the acquisition of the structure is carried out by means of laser scanning.

6. The method of claim 1, characterized in that the acquisition of the specification point cloud is carried out from CAD data of the specification structure of the individual parts.

7. The method of claim 1, characterized in that the calculation of the specification point cloud is carried out in such a way that the specification point cloud only comprises the surface structure acquirable for a predetermined 3D scanning process.

8. The method of claim 7, characterized in that the calculation of the specification point cloud is carried out while taking the scanner perspective into account.

9. The method of claim 1, characterized in that the measurement point cloud is decomposed into a multiplicity of measurement point cloud regions before the fitting with the specification point cloud, each measurement point cloud region comprising the specification position of one or more mounting components.

10. The method of claim 1, characterized in that a list of fitting results is created, in which missing, surplus and/or matching individual parts are listed with their measurement and specification positions.

11. The method of claim 1, characterized in that the greatest dimension of an individual part is from 2 to 30 cm.
